(19) United States
(12) Patent Application Publication
(10) Pub. No.: US 2025/0253707 A1
(43) Pub. Date: Aug. 7, 2025

(54) APPARATUSES AND METHODS FOR DYNAMIC WIRELESS CHARGING WITH A UNIQUE PCB RECEIVER COIL

(71) Applicant: Toyota Motor Engineering and Manufacturing North America, Inc., Plano, TX (US)

(72) Inventors: Jae Seung LEE, Ann Arbor, MI (US); Yanghe LIU, Ann Arbor, MI (US); Ercan Mehmet DEDE, Ann Arbor, MI (US)

(73) Assignees: Toyota Motor Engineering and Manufacturing North America, Inc., Plano, TX (US); Toyota Jidosha Kabushiki Kaisha, Aichi-ken (JP)

(21) Appl. No.: 18/431,655

(22) Filed: Feb. 2, 2024

(51) Int. Cl. H02J 50/10; B60L 53/122; H01F 27/28; H01F 41/04; H02J 50/00

(52) U.S. Cl. CPC H02J 50/10; B60L 53/122; H01F 27/28; H01F 41/04; H02J 50/005

(57) ABSTRACT

An apparatus and method of making the apparatus for a wireless device. The wireless device may include a substrate. The wireless device may further include a receiver coil with a plurality of windings around the substrate. The wireless device may further include a plurality of air gaps between at least a portion of the plurality of windings around the substrate, wherein the plurality of air gaps may extend completely through one side of the substrate to an opposite side of the substrate.

### BACKGROUND

Wireless inductive charging systems for electric vehicles (EVs) generally include a receiver and rectifier to transfer power from a magnetic or electromagnetic field, applied in the vicinity of the receiver, to provide electric power for the electric vehicles. The receiver is typically placed or mounted on the bottom of the electric vehicle (EV) such that a transmitter can be placed in proximity to the receiver to expose the receiver to a changing magnetic field. Printed Circuit Board (PCB) based coils may be used for the wireless power transfer.

### SUMMARY

In one example implementation, a method for creating a wireless device may include but is not limited to fabricating a substrate with a receiver coil having a plurality of windings around the substrate. A plurality of air gaps may be created between at least a portion of the plurality of windings around the substrate, wherein the plurality of air gaps may extend completely through one side of the substrate to an opposite side of the substrate.

One or more of the following example features may be included. The substrate may include a printed circuit board (PCB) having the receiver coil with the plurality of windings embedded within the PCB. A wing shaped edge may be coupled below the PCB. A plurality of air gaps of the wing shaped edge may be aligned with the plurality of air gaps between at least the portion of the plurality of windings around the substrate. The substrate may be fabricated as a wing shaped edge, and fabricating the substrate may include embedding the receiver coil with the plurality of windings within the wing shaped edge. Creating the plurality of air gaps between at least the portion of the plurality of windings around the substrate may include creating at least a portion of the air gaps at one of a diagonal angle, a 90-degree angle, longitudinal, and latitudinal.

In another example implementation, a wireless device may include but is not limited to a substrate. The wireless device may further include a receiver coil with a plurality of windings around the substrate. The wireless device may further include a plurality of air gaps between at least a portion of the plurality of windings around the substrate, wherein the plurality of air gaps may extend completely through one side of the substrate to an opposite side of the substrate.

One or more of the following example features may be included. The substrate may include a printed circuit board (PCB) having the receiver coil with the plurality of windings embedded within the PCB. The substrate may further include a wing shaped edge coupled below the PCB. The wing shaped edge may include a plurality of air gaps that align with the plurality of air gaps between at least the portion of the plurality of windings around the substrate. The substrate may be a wing shaped edge having the receiver coil with the plurality of windings embedded within the wing shaped edge. The plurality of air gaps between at least the portion of the plurality of windings around the substrate may be at least one of at a diagonal angle and at a 90-degree angle. The plurality of air gaps between at least the portion of the plurality of windings around the substrate may be at least one of longitudinal and latitudinal.

In another example implementation, a wireless charging device may include but is not limited to a substrate. The wireless charging device may further include a receiver coil with a plurality of windings around the substrate. The wireless charging device may further include a plurality of air gaps between at least a portion of the plurality of windings around the substrate, wherein the plurality of air gaps may extend completely through one side of the substrate to an opposite side of the substrate.

One or more of the following example features may be included. The substrate may include a printed circuit board (PCB) having the receiver coil with the plurality of windings embedded within the PCB. The substrate may further include a wing shaped edge coupled below the PCB. The wing shaped edge may include a plurality of air gaps that align with the plurality of air gaps between at least the portion of the plurality of windings around the substrate. The substrate may be a wing shaped edge having the receiver coil with the plurality of windings embedded within the wing shaped edge. The plurality of air gaps between at least the portion of the plurality of windings around the substrate may be at least one of at a diagonal angle and at a 90-degree angle. The plurality of air gaps between at least the portion of the plurality of windings around the substrate may be at least one of longitudinal and latitudinal.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a wireless charging device according to one or more example implementations of the disclosure;

FIG. 2 is an example diagrammatic view of a wireless charging device according to one or more example implementations of the disclosure;

FIG. 3 is an example diagrammatic view of a wireless charging device according to one or more example implementations of the disclosure; and

FIG. 4 is an example flowchart of a fabrication process according to one or more example implementations of the disclosure.

Like reference symbols in the various drawings may indicate like elements.

### DESCRIPTION

Wireless inductive charging systems for electric vehicles (EVs) generally include a receiver and rectifier to transfer power from a magnetic or electromagnetic field, applied in the vicinity of the receiver, to provide electric power for the electric vehicles. The receiver is typically placed or mounted on the bottom of the electric vehicle (EV) such that a transmitter can be placed in proximity to the receiver to expose the receiver to a changing magnetic field. Printed Circuit Board (PCB) based coils may be used for the wireless power transfer, although other coils may be used as well. When used, they can overheat. Therefore, as will be discussed in greater detail below, the present disclosure may provide an EV PCB wireless charging receiver coil with passive cooling. In some implementations, the PCB-based receiver coil may include air gaps between PCB copper windings in combination with a wing-shaped leading edge to force air to flow through the PCB based receiver coil-due to pressure differences created by the wing shaped leading edge.

In some implementations, the present disclosure may be embodied as a method, system/apparatus, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

Examples of processing hardware may include, e.g., a central processing unit (CPU), a graphics processing unit (GPU), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

In some implementations, the flowchart and block diagrams in the figures illustrate the architecture, functionality, and operation of possible implementations of apparatus (e.g., systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The following example is described as being a wireless charging device for an EV; however, it will be appreciated that the present disclosure may be used to charge other things, and may also be a wireless device used for other purposes, such as being attached to power electronics with copper coils that need to be air-cooled. Without limitations, the wing-shaped structure is mainly for driving air through the small gaps between traces or small devices passively. This may enhance convection without consuming additional power. As such, the description of a wireless charging device for EV charging should be taken as example only and not to otherwise limit the scope of the present disclosure.

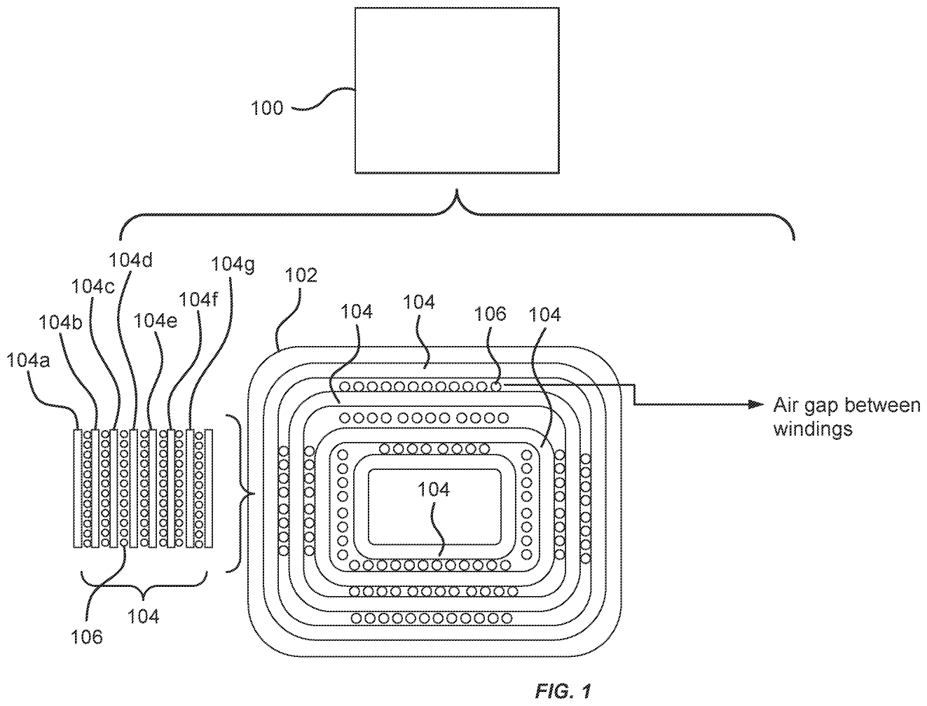

As discussed above and referring also at least to the example implementations of FIGS. 1-4, a wireless charging device may include but is not limited to a substrate. The wireless charging device may further include a receiver coil with a plurality of windings around the substrate. The wireless charging device may further include a plurality of air gaps between at least a portion of the plurality of windings around the substrate, wherein the plurality of air gaps may extend completely through one side of the substrate to an opposite side of the substrate.

In some implementations, a wireless charging device (e.g., wireless charging device 100) may include but is not limited to a substrate, and in some implementations, wireless charging device 100 may further include a receiver coil with a plurality of windings (e.g., windings 104) around the substrate. For instance, and referring at least to the example implementation of FIG. 1, wireless charging device 100 is shown. In some implementations, the substrate may include a printed circuit board (PCB) (e.g., PCB 102). In the example, PCB 102 has a receiver coil with a plurality of windings 104 (e.g., copper windings) around PCB 102 and embedded within the PCB. In some implementations, windings 104 may be copper windings, although any suitable material may be used without departing from the scope of the present disclosure.

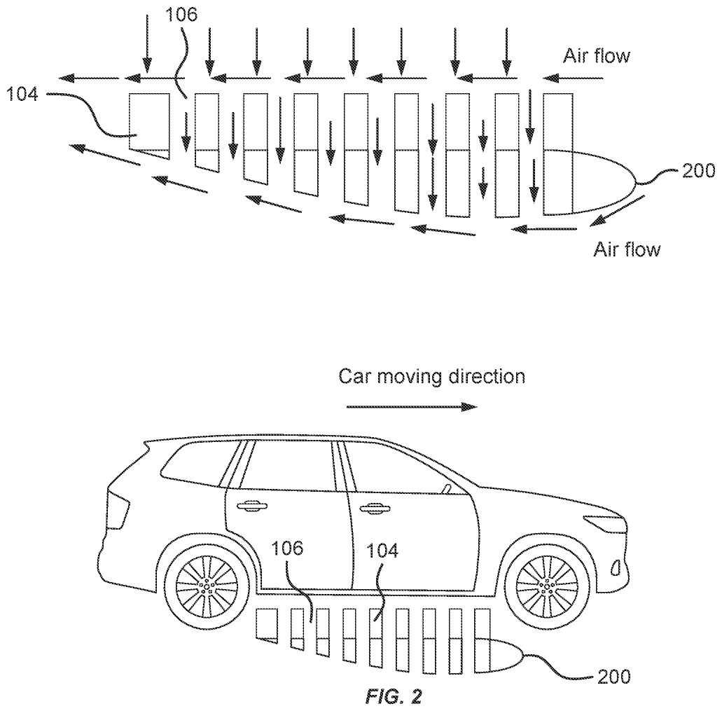

In some implementations, the wireless charging device may further include a plurality of air gaps (e.g., air gaps 106) between at least a portion of the plurality of windings around the substrate, wherein the plurality of air gaps may extend completely through one side of the substrate to an opposite side of the substrate. For instance, and referring at least to the example implementation of FIG. 2, the substrate may further include a wing shaped edge (e.g., wing shaped edge 200) coupled below the PCB with windings 104. In the example, wing shaped edge 200 is shown to include a plurality of air gaps that align with the plurality of air gaps between at least the portion of the plurality of windings around the substrate. Thus, it can be seen that air gaps 106 extend all the way through the top side of PCB between the windings (as shown in FIG. 1) and completely through wing shaped edge 200. In some implementations, each air gap may be, e.g., 1-2 mm apart, with a width of 0.8 mm; however, it will be appreciated that other spacing and widths may be used depending on the application of wireless charging device 100.

In some implementations, wing shaped edge 200 may be a non-metal (e.g., resin, plastic, fiberglass, etc.) compact cross-section wing shaped leading edge, which as noted above, may include air gaps that align with the air gaps coupled to the PCB based receiver coil. An example of wireless charging device 100 coupled to an EV is also shown in FIG. 2. When driving, air flow may travel through the air gaps between the windings of the PCB receiver coil due to the air pressure differences caused by the design of wing shaped edge 200 (i.e., similar to the principle of “lift” with aircraft”), thus providing a technique to cool components without needing to consume other resources (e.g., battery power to run a fan). The passive wing-shaped cooling design is more suitable for high power applications, e.g., dynamic wireless power transfer higher than 30 kW. In this example case, the PCB-based coil pad is always thick with multiple layers of copper traces. Surface heat spreading is not enough to cool the board sufficiently. This wing-shaped design coupled with air gaps between windings can efficiently take internal heat away. That is, wing shaped edge 200 may function as a compact profile airplane wing that creates pressure differences between the upper surface of the PCB based receiver coil and the lower surface of wing shaped edge 200 such that air flows through the air gaps and cools the PCB based receiver coil.

In some implementations, the plurality of air gaps between at least the portion of the plurality of windings around the substrate may be at least one of longitudinal and latitudinal. For instance, and referring back to the example implementation of FIG. 1, windings 104 may each consist of smaller individual windings 104a-g as is known in the art. As shown in FIG. 1, air gaps 106 may be latitudinal (between each set of complete windings 104) and/or may be longitudinal (between each individual windings 104a-104g of a set of complete windings 104).

In some implementations, the plurality of air gaps between at least the portion of the plurality of windings around the substrate may be at least one of at a diagonal angle and at a 90-degree angle. For instance, air gaps 106 may be created at a 90-degree angle (as shown in FIG. 2); however, in some implementations, air gaps may be created at other angles, such as from 1-degree to 89-degrees (i.e., diagonal). In some implementations, there may be combinations of different angled air gaps, and different shaped air gaps (e.g., cylindrical, cuboid, cube, pyramid, prism, canonical, etc.

In some implementations, adding air gaps 106 can increase the airflow for better cooling; however, this may also reduce the strength of the PCB. To increase the reliability of the PCB, the density of air gaps 106 may be adjusted. For example, in the PCB coil wireless power transfer, the inner layer may always be hotter (because of more current induced in this region) than the outer layers. Thus, the number and/or size of air gaps 106 may be denser at the center, while having fewer air gaps outside to keep the board strong.

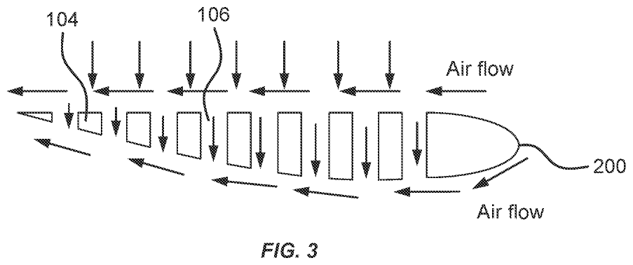

In some implementations, the substrate may be a wing shaped edge having the receiver coil with the plurality of windings embedded within the wing shaped edge. For instance, and referring at least to the example implementation of FIG. 3, wing shaped edge 200 is shown with air gaps 106, and is also shown with windings 104 embedded within wing shaped edge 200. In the example, a PCB is not needed, as windings 104 are embedded within wing shaped edge 200.

Therefore, as will be discussed in greater detail below, the present disclosure may provide an EV PCB wireless charging receiver coil with passive cooling. In some implementations, the PCB-based receiver coil may include air gaps between PCB copper windings in combination with a wing-shaped leading edge to force air to flow through the PCB based receiver coil-due to pressure differences created by the wing shaped leading edge.

An example fabrication process of the disclosed wireless charging device 100 may include fabrication process 110 performing a coil PCB board standard fabrication, creating and attaching wing shaped edge 200 to the PCB, and then drilling and machining the air gap between the coils. In some implementations, wireless charging device 100 and/or the substrate may be created as a single mold with the air gaps shaped in the mold.

As discussed above and referring also at least to the example implementations of FIGS. 1-4, fabrication process 110 may create 400 a wireless device may include but is not limited to fabricating a substrate with a receiver coil having a plurality of windings around the substrate. In some implementations, fabrication process 110 may create 402 a plurality of air gaps between at least a portion of the plurality of windings around the substrate, wherein the plurality of air gaps may extend completely through one side of the substrate to an opposite side of the substrate. The substrate may include a printed circuit board (PCB) having the receiver coil with the plurality of windings embedded within the PCB. In some implementations, fabrication process 110 may couple 404 a wing shaped edge below the PCB. In some implementations, fabrication process 110 may align 406 a plurality of air gaps of the wing shaped edge with the plurality of air gaps between at least the portion of the plurality of windings around the substrate. In some implementations, the substrate may be fabricated as a wing shaped edge, and fabricating the substrate may include embedding 408 the receiver coil with the plurality of windings within the wing shaped edge. In some implementations, creating the plurality of air gaps between at least the portion of the plurality of windings around the substrate may include creating 410 at least a portion of the air gaps at one of a diagonal angle, a 90-degree angle, longitudinal, and latitudinal.

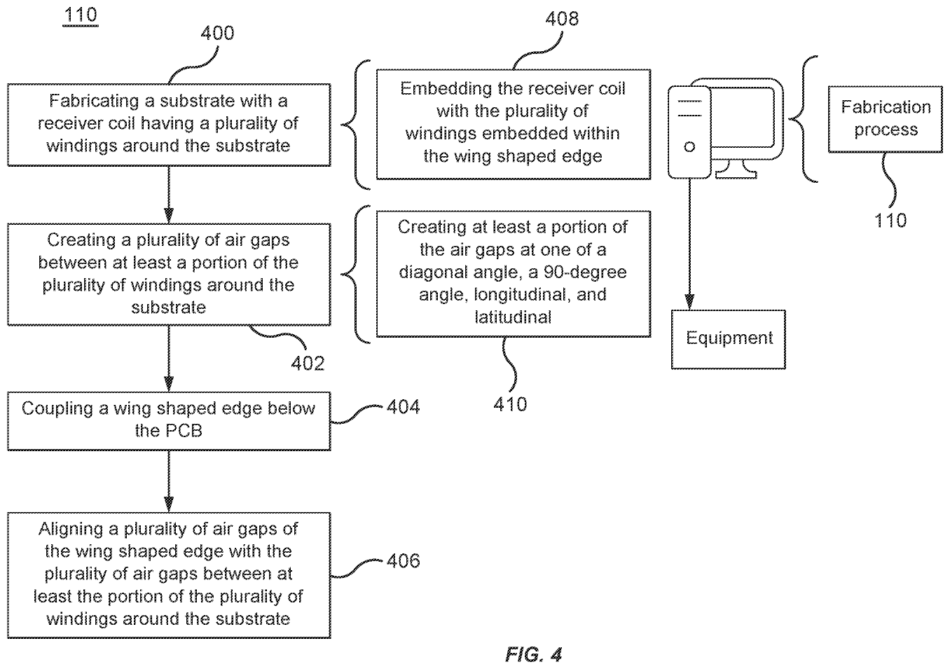

It will be appreciated after reading the present disclosure that any standard PCB assembly/printing/fabrication, etc. equipment, as well as any other necessary equipment, may be used singly or in any combination with fabrication process 110, which may be operatively connected to a computing device, such as the computing device shown in FIG. 4, to obtain their instructions for creating one or more aspects of the present disclosure. In one or more example implementations, the respective flowcharts may be manually-implemented, computer-implemented, or a combination thereof

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “coupled,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A wireless charging device comprising:
a substrate;
a receiver coil with a plurality of windings around the substrate; and
a plurality of air gaps between at least a portion of the plurality of windings around the substrate, wherein the plurality of air gaps extends completely through one side of the substrate to an opposite side of the substrate.

2. The wireless charging device of claim 1, wherein the substrate includes a printed circuit board (PCB) having the receiver coil with the plurality of windings embedded within the PCB.

3. The wireless charging device of claim 2, wherein the substrate further includes a wing shaped edge coupled below the PCB.

4. The wireless charging device of claim 3, wherein the wing shaped edge includes a plurality of air gaps that align with the plurality of air gaps between at least the portion of the plurality of windings around the substrate.

5. The wireless charging device of claim 1, wherein the substrate is a wing shaped edge having the receiver coil with the plurality of windings embedded within the wing shaped edge.

6. The wireless charging device of claim 1, wherein the plurality of air gaps between at least the portion of the plurality of windings around the substrate are at least one of at a diagonal angle and at a 90-degree angle.

7. The wireless charging device of claim 1, wherein the plurality of air gaps between at least the portion of the plurality of windings around the substrate are at least one of longitudinal and latitudinal.

8. A wireless device comprising:
a substrate;
a receiver coil with a plurality of windings around the substrate; and
a plurality of air gaps between at least a portion of the plurality of windings around the substrate, wherein the plurality of air gaps extends completely through one side of the substrate to an opposite side of the substrate.

9. The wireless device of claim 8, wherein the substrate includes a printed circuit board (PCB) having the receiver coil with the plurality of windings embedded within the PCB.

10. The wireless device of claim 9, wherein the substrate further includes a wing shaped edge coupled below the PCB.

11. The wireless device of claim 10, wherein the wing shaped edge includes a plurality of air gaps that align with the plurality of air gaps between at least the portion of the plurality of windings around the substrate.

12. The wireless device of claim 8, wherein the substrate is a wing shaped edge having the receiver coil with the plurality of windings embedded within the wing shaped edge.

13. The wireless device of claim 8, wherein the plurality of air gaps between at least the portion of the plurality of windings around the substrate are at least one of at a diagonal angle and at a 90-degree angle.

14. The wireless device of claim 8, wherein the plurality of air gaps between at least the portion of the plurality of windings around the substrate are at least one of longitudinal and latitudinal.

15. A method of creating a wireless device comprising:
fabricating a substrate with a receiver coil having a plurality of windings around the substrate; and
creating a plurality of air gaps between at least a portion of the plurality of windings around the substrate, wherein the plurality of air gaps extends completely through one side of the substrate to an opposite side of the substrate.

16. The method of claim 15, wherein the substrate includes a printed circuit board (PCB) having the receiver coil with the plurality of windings embedded within the PCB.

17. The method of claim 16, further comprising coupling a wing shaped edge below the PCB.

18. The method of claim 17, further comprising aligning a plurality of air gaps of the wing shaped edge with the plurality of air gaps between at least the portion of the plurality of windings around the substrate.

19. The method of claim 15, wherein the substrate is fabricated as a wing shaped edge, and wherein fabricating the substrate includes embedding the receiver coil with the plurality of windings within the wing shaped edge.

20. The method of claim 15, wherein creating the plurality of air gaps between at least the portion of the plurality of windings around the substrate includes creating at least a portion of the air gaps at one of a diagonal angle, a 90-degree angle, longitudinal, and latitudinal.
